(19) United States
(12) Patent Application Publication
(10) Pub. No.: US 2013/0004146 A1
(43) Pub. Date: Jan. 3, 2013

(54) RECORDING DEVICE AND DUBBING METHOD

(75) Inventors: Yuki Kaneko, Inagi-shi (JP); Takashi Mori, Ome-shi (JP); Katsuya Yuri, Fuchu-shi (JP)

(73) Assignee: KABUSHIKI KAISHA TOSHIBA, Tokyo (JP)

(21) Appl. No.: 13/466,540

(22) Filed: May 8, 2012

(30) Foreign Application Priority Data
Jun. 30, 2011 (JP) 2011-145959

(51) Int. Cl. H04N 5/93; H04N 7/26

(52) U.S. Cl. 386/353; 375/240.24; 386/E05.028; 375/E07.026

(57) ABSTRACT

According to at least one embodiment, a transmitting apparatus includes a dividing module configured to divide one recorded content into block data items, encoding modules configured to encode a plurality of block data items divided by the dividing module for the respective block data items, and a transmitting module configured to transmit the plurality of block data items encoded by the encoding modules together with arrangement information indicating a position of content before division by the dividing module with a degree M of parallelization of at least M=1.

### CROSS-REFERENCE TO RELATED APPLICATIONS

This application is based upon and claims the benefit of priority from prior Japanese Patent Application No. 2011-145959, filed Jun. 30, 2011, the entire contents of which are incorporated herein by reference.

### FIELD

Embodiments described herein relate generally to a recording device and dubbing method.

### BACKGROUND

If content items are divided and can be processed in parallel when recorded content items (programs) are copied (dubbed), a processing time required for copying can be greatly reduced.

When content items are divided, a code key process and a method for reconstructing divided content items are required.

Particularly, copying of content items that is not predicted and can be executed by division must be avoided.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary diagram showing an example of a recording device and receiving device, according to an embodiment;

FIG. 2A and FIG. 2B are exemplary diagrams, each showing an example of parallel transmission, according to an embodiment;

FIG. 3 is an exemplary diagram showing an example of a degree of parallelization of parallel transmission, according to an embodiment;

FIG. 4 is an exemplary diagram showing an example of parallel reception, according to an embodiment;

FIG. 5 is an exemplary diagram showing an example of a recording device and receiving device, according to an embodiment;

FIG. 6 is an exemplary diagram showing an example of a recording device and receiving device, according to an embodiment;

FIG. 7 is an exemplary diagram showing an example of an identity checking process for divided blocks, according to an embodiment;

FIGS. 8A, 8B and 8C are exemplary diagrams each showing an example of an identity checking process for divided blocks, according to an embodiment;

FIG. 9 is an exemplary diagram showing an example of an identity checking process for divided, according to an embodiment;

FIG. 10 is an exemplary diagram showing an example of an identity checking process for divided blocks, according to an embodiment;

FIG. 11 is an exemplary diagram showing an example of a copy control process, according to an embodiment;

FIG. 12 is an exemplary diagram showing an example of a copy control process, according to an embodiment;

FIG. 13 is an exemplary diagram showing an example of a copy control process, according to an embodiment;

FIG. 14 is an exemplary diagram showing an example of a copy control process, according to an embodiment;

FIG. 15 is an exemplary diagram showing an example of a recording device and receiving device, according to an embodiment;

FIG. 16 is an exemplary diagram showing an example of a recording device and receiving device, according to an embodiment;

FIG. 17 is an exemplary diagram showing an example of a recording device and receiving device, according to an embodiment;

FIG. 18 is an exemplary diagram showing an example of a recording device and receiving device, according to an embodiment; and

FIG. 19 is an exemplary diagram showing an example of “divided information” related to divided and moved content items, according to an embodiment.

### DETAILED DESCRIPTION

Various embodiments will be described hereinafter with reference to the accompanying drawings. In general, according to one embodiment, a transmitting apparatus comprising: a dividing module configured to divide one recorded content into block data items; encoding modules configured to encode a plurality of block data items divided by the dividing module for the respective block data items; and a transmitting module configured to transmit the plurality of block data items encoded by the encoding modules together with arrangement information indicating a position of content before division by the dividing module with a degree M of parallelization of at least M=1.

Embodiments will now be described hereinafter in detail with reference to the accompanying drawings.

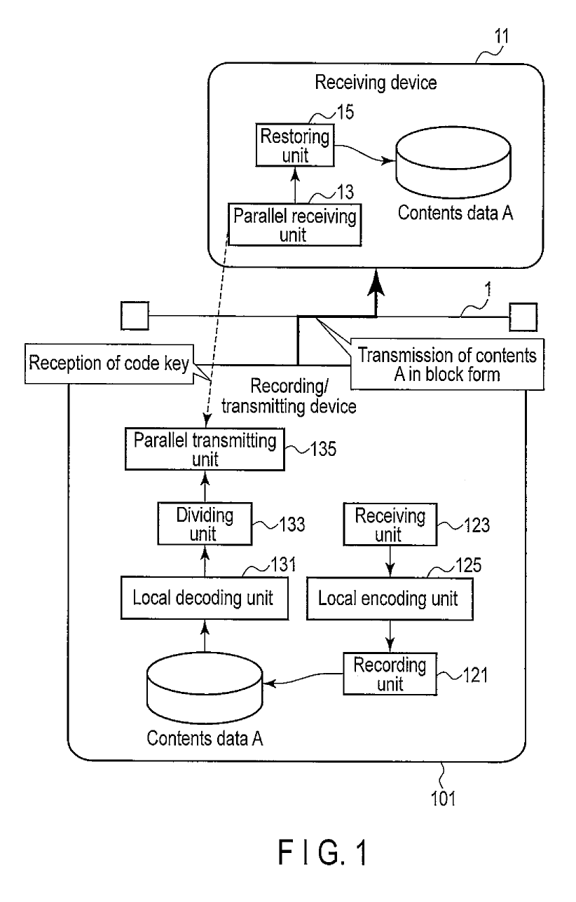

FIG. 1 shows an example in which a recording (transmitting) device and receiving (recording) device according to an embodiment are connected. For example, each of the recording devices may be a personal computer (PC) or a television receiver having a recording device integrally provided therein. Further, each element/configuration explained below may be realized based on hardware or realized based on software by means of a microcomputer (processing device, CPU) or the like.

A recording system shown in FIG. 1 includes at least one recording (transmitting) device 101 connected to a network (local area network [LAN]) 1 and at least one receiving (recording) device 11 connected to the same network. The devices are called as the transmitting device 101 and receiving device 11 in the following description.

Further, the transmitting device 101 and receiving device 11 may have substantially the same configuration and, for example, the receiving device 11 can be used as a transmitting device and the transmitting device 101 can be used as a receiving device. Further, the transmitting device and receiving device are not dominated by the names thereof and can play back information (content/program/title).

The network 1 is preferably a network constructed according to a rule defined based on, for example, Digital Living Network Alliance (DLNA) in which a mutual connection is assumed mainly in a home or small-scale establishment. For example, a server (home server) 3 that holds information (content/program/title) may be connected to the LAN 1. Further, each recording device may be directly connected to the server 3 without using the LAN 1 by using a High-definition Digital Media Interface (HDMI) cable or LAN cable (communication line) or a combination thereof.

For example, transfer of information between the mutual recording devices may be performed based on a radio system (transmission or reception of information via a router of a wireless system). When the server 3 is connected, it can be used as a database referred at the time of copying (dubbing) of information, explained later.

Further, the transmitting device or receiving device may be a device that mainly holds data like a network attached storage (NAS) hard disk drive (HDD) or the like. Alternatively, it may be a terminal device having a reception unit (tuner unit), encoder/decoder or the like prepared on the HDD.

The transmitting device or receiving device may be a multi-functional electronic device or the like in which a mobile recording device (receiving device), a user interface unit for the recording device (receiving device), for example, a touch panel, keyboard and the like and a communication function are integrally provided, also.

Further, the given recording device or receiving device can be provided together with a display device (monitor/display) prepared, for example, on the external portion or a display unit integrally prepared and a GUI or the like that is explained later is visually displayed for direct visual observation (or viewable) by the user when the display device or display unit is provided.

Still further, for example, the given recording device or receiving device may be integrally prepared together with a rack (storage shelf) that stores or holds a television receiver for receiving a television broadcast or the like and playing back the content thereof or an audio device that integrally has speakers and amplifier.

For example, the transmitting device 101 has a storage unit (storage area) 121 as represented by an HDD or Secure Digital (SD) memory card and can record digital information (content/program/title) that is hereinafter referred to as “content item A” encoded according to a preset standard. As the standard of recordable (treatable) digital information, for example, MPEG (Moving Picture Experts Group)-1, -2, -4 (H.264/AVC) in Video (moving picture), for example, MP3 (MPEG Audio Layer-3), AC3 (Audio Code number 3), linear PCM (Pulse Coded Module) in Audio (speech/music) and, for example, JPEG (joint Photographic Experts Group) or the like in Still (still picture) may be provided.

For example, “content item A” held by the recording unit 121 is acquired from the exterior by means of a receiving unit 123 and encoded in a local encoding unit 125. “Content item A” is decoded by means of a local decoding unit 131 at the time of transmission to the recording device 11, divided into a preset number of portions in a dividing unit 133 and transmitted in a block form from a parallel transmitting unit 135. The parallel transmitting unit 135 includes (local) encoding units corresponding in number to the degree of parallelization explained below.

The receiving device 11 receives “content item A” transmitted in parallel (transmitted in a block form) by the transmitting device 101 and divided into a preset number of portions in a parallel receiving unit 13 and reconstructs the same as “content item A” (the original form of “content item A” is reconstituted/restored) by means of a restoring unit 15. The parallel receiving unit 13 includes (local) decoding units of the same number as that of (local) encoding units provided in the parallel transmitting unit 135, that is, of a number corresponding to the degree of parallelization explained below.

That is, in the recording (transmitting) device 101, content data (“content item A”) received by the receiving unit 123 is locally encoded, recorded and held, and when a transfer request is issued from the receiving device 11, content data is divided into block data and transmitted in parallel while content data is being locally decoded.

Block data transmitted in parallel is received by means of the parallel receiving unit 13 of the receiving unit 11 and the received block data is restored to content data by means of the restoring unit 15.

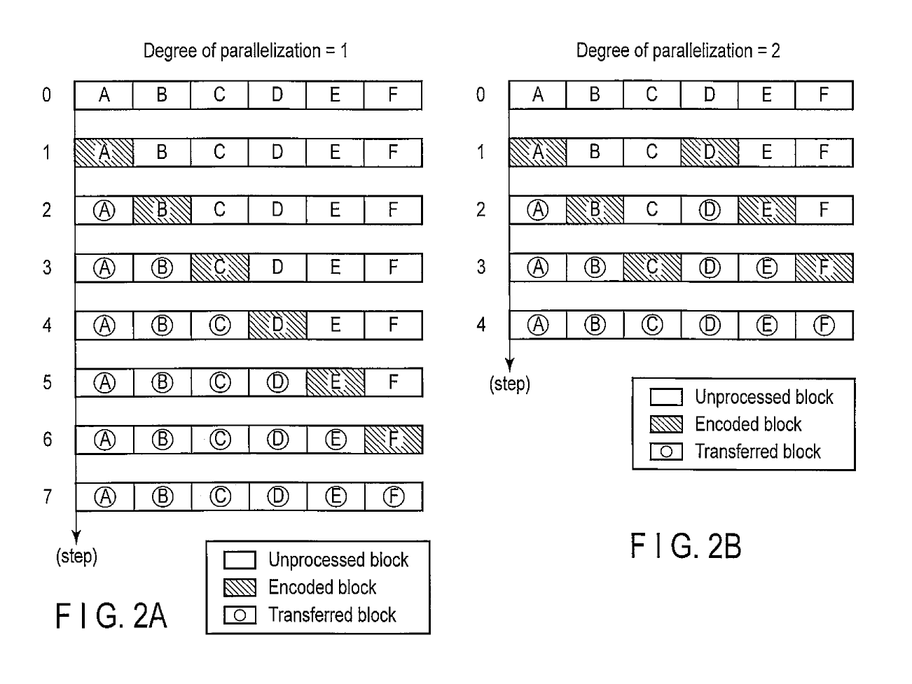

FIGS. 2A and 2B show the concept of the above parallel-transmission (parallel-reception) process.

As shown in FIG. 2B, for example, when the degree of parallelization is set to m (m=2<the number of content supply sources>), for example, a time required for transfer is reduced to ½ at maximum by transmitting [A] and [D], [B] and [E] and [C] and [F] in parallel among content data (content item A) divided into six portions of [A] to [F] in comparison with an example in which [A] to [F] are serial transmitted as shown in FIG. 2A.

That is, in the transmitting device 101, content data is divided into a plurality of blocks in the preset unit, the individual blocks are encoded in parallel and transmitted and then the individual block-form content data is decoded in the receiving device 11 and reconstructed. As a result, parallel-transmission (parallel-reception) becomes possible while unwanted access to content item A from the exterior is excluded.

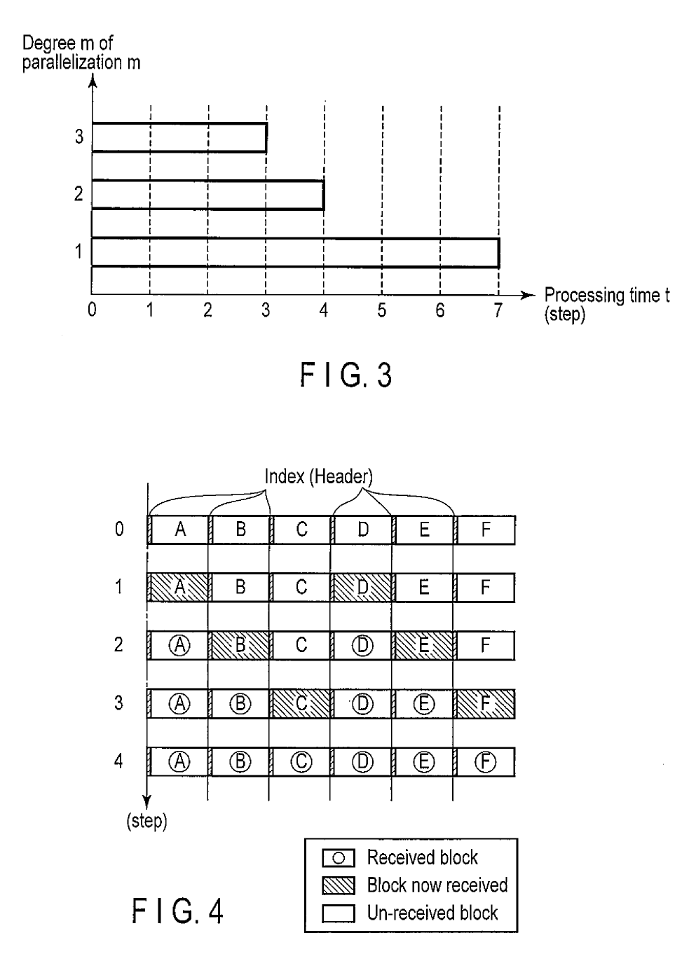

FIG. 3 shows the degree (m) of parallelization and a processing time required for transmission and reception.

As shown in FIG. 3, when the number of divisions of content data is seven, for example, and if the degree (m) of parallelization is m=2, the processing time required for transmitting (receiving) all of the content becomes 4/7 in comparison with a case of simple sequential transmission (reception). Likewise, when the number of divisions is seven, for example, and if the degree (m) of parallelization is m=3, the processing time required for transmitting (receiving) all of the content becomes 3/7 in comparison with a case of simple sequential transmission (reception).

FIG. 4 shows an example of a process before starting transfer (transmission) of individual blocks used for realizing reconstruction of blocks transmitted in parallel (transmitted in a block form) and received.

In FIG. 4, when “content item A” are divided into a block form of six blocks [A] to [F] in step [0], at least one of an index (description of identification information), header (front-side end identification information) or footer (rear-side end identification information) is provided, for example, on the head of each block or a reconstruction (restoration) code that is “resume information indicating that blocks are the same content and the content of a former (an immediately preceding) block and a trailing (a present) block are a series of content free from overlapping, omission or the like” is provided on the head and end of each block. The index, header, footer or resume information, that is, the reconstruction (restoration) code will be explained in detail later.

By applying the index, header, footer or resume information shown in FIG. 4 to the individual blocks formed in a block form, the order of block data items can be restored in the receiving device 11 even if the reception order of block data items received by the receiving device 11 is random order. In this case, the reconstruction (restoration) code attached to block data is transmitted from the transmitting device 101 to the receiving device 11. Prior to transmission of block data from the transmitting device 101 to the receiving device 11, a code key for encoding individual block data items is transmitted from the receiving device 11 (to the transmitting device 101). As a result, individual block data transmitted from the transmitting device 101 can be securely transferred (moved) to the receiving device 11.

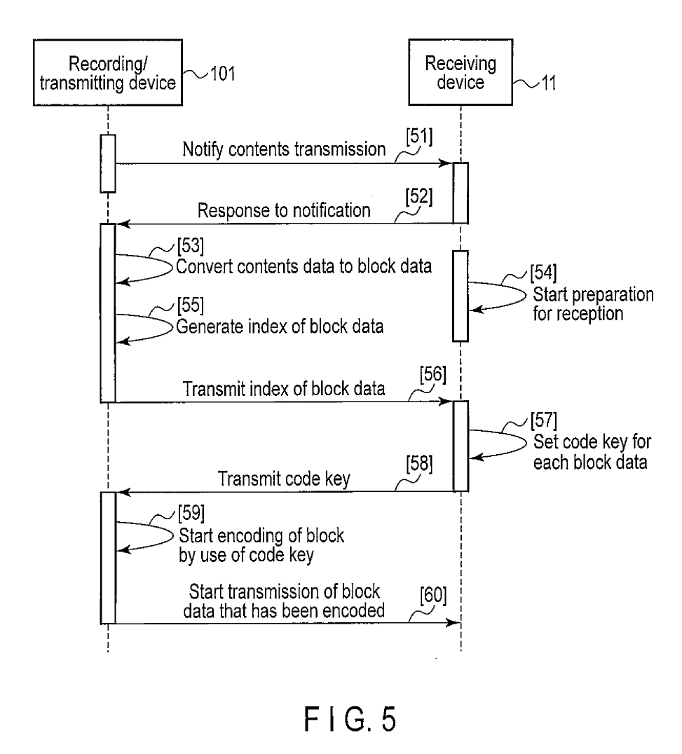

FIG. 5 shows an example of a sequence related to transfer of block data between the transmitting device and the receiving device.

When receiving a reconstruction (restoration) code simultaneously or previously supplied from the transmitting device by use of, for example, a [DIM (dimension)] code belonging to block data, the receiving device 11 can reconstruct content data based on block data received in random order in correspondence to the reconstruction (restoration) code by acquiring a buffer that holds all of or a preset number of block data items from the recording device. That is, the receiving device 11 receives the arrangement information and the number of block data items supplied from the transmitting device 101, previously acquires a preset number of buffers, stores block data items sequentially received into corresponding buffers and reconstructs content data.

More specifically, if content transmission is notified from the transmitting device (101) to the receiving device (11) [51], a reply in response to the (content transmission) notification is issued from the receiving device to the transmitting device [52].

When receiving the reply in response to the (content transmission) notification from the receiving device to the transmitting device, the transmitting device converts content data to block data [53]. During this time, the receiving device starts a reception preparation for block data [54].

On the other hand, the transmitting device generates an index, header, footer or resume information, that is, reconstruction (restoration) code attached to each block data in parallel with conversion of content data to block data or at preset timing [55] and transmits the generated index, that is, reconstruction (restoration) code to the receiving device [56].

The receiving device that receives the index, that is, reconstruction (restoration) code from the transmitting device sets a code key corresponding to each block data [57] and transmits the set code key to the transmitting device [58].

The transmitting device that receives the code key from the receiving device encodes the individual block data by using a corresponding code key [59] and sequentially transmits coded block data items to the receiving device [60].

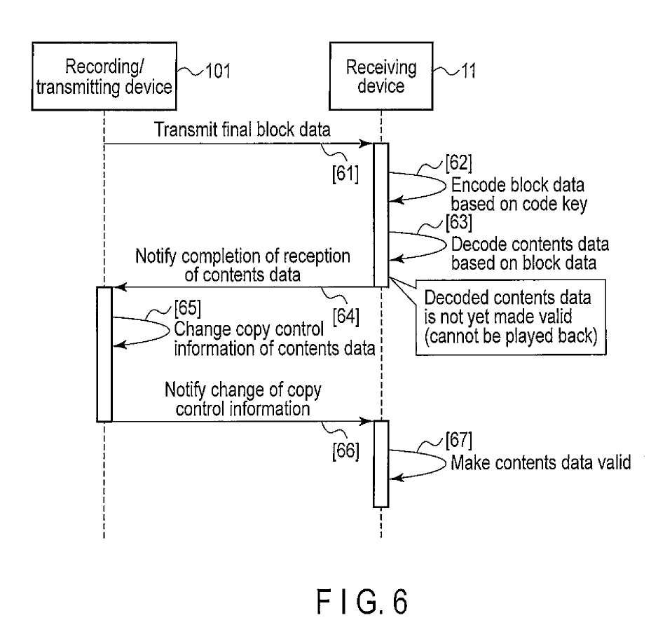

FIG. 6 shows an example of a sequence of the reception process on the receiving device side that receives coded block data from the transmitting device.

After completing restoration of content data from all of the received block data items, the receiving device 11 issues a request for changing copy control information of content data to the recording device 101 and then updates the same after reception. That is, after confirming that copy control information of content data on the transmitting device 101 side is updated in the receiving device 11, content data becomes valid on the receiving device 11 side (“content item A (content data) received by the receiving device 11 can be played back”.

Specifically, the recording device 11 receives final block data transmitted from the transmitting device 101 [61] and decodes the block data by using a code key [62].

Then, content data is decoded based on the block data. At this time, compounded content data cannot be played back (invalid) [63].

If content data is successfully decoded, completion of reception of content data is notified from the receiving device to the transmitting device [64].

The transmitting device that has received completion of reception (from the receiving device) changes copy control information of content data [65] and notifies a change of copy control information to the receiving device [66].

After this, a change of copy control information of content data is received by the receiving device, that is, copy control information is updated, and content data can be made valid (can be played back) [67].

As described above, individual block data transmitted from the transmitting device 101 can be securely transferred (moved) to the receiving device 11 while a playback process by unwanted access from the exterior is excluded. At this time, high-speed transmission corresponding to the degree (m) of parallelization can be achieved.

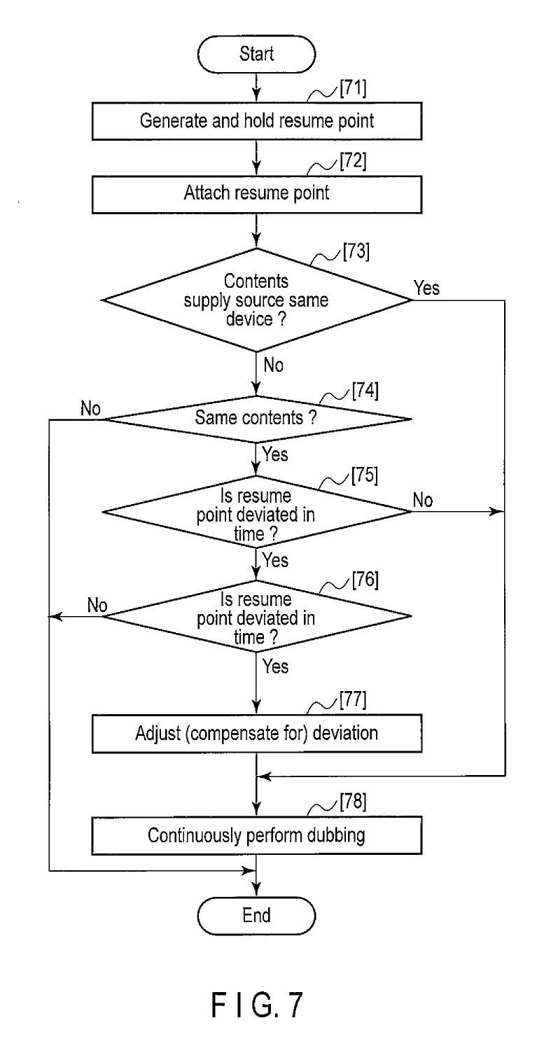

A process for checking that divided block data items are “the same content and a series of content free from omission, overlapping between mutual data items or the like” is explained with reference to FIG. 7. The content explained below can be checked by use of substantially the same method in the above resume point information, that is, the index, header or footer indicated as the reconstruction (restoration) code.

It is necessary for block data items received by the receiving device to have the same time series for reconstruction (restoration) because content item A transmitted from the transmitting device are divided in a preset number of block data items.

Therefore, for example, divided individual block data items include at least “recording date and time”, “time information at dividing time” and “title (content name)” as resume point information. Further, if content item A are supplied as a television broadcast signal, for example, highly precise comparison can be made by using “EPG (Electric Program Guide) information” [71].

Therefore, resume point information is attached to each block data in the transmitting device before transmitted to the receiving device [72].

In this case, the receiving device confirms that the transmitting device that is a supply (transmission) source of block data is the same recording device [73].

If the transmitting devices for mutual block data items are the same [73-YES], the receiving device stores received block data in a previously provided buffer (copying is continuously performed) [78]. The fact that the transmitting devices that have supplied block data are the same can be easily confirmed by, for example, referring to a MAC (Media Access Control) address in a device having a function mutually or mainly as a server in the network 1. Further, for example, if the supply source of content item A used as a basis of block data is a digital (still picture) camera or digital video camera, it can be easily confirmed by referring to the “folder structure defined based on DCF (or Exif)”/““(Product) maker name (or supplier name)” belonging to (DCF)”/“type (model) name”” attached to individual content items.

If the block data sources are not the same [73-NO], resume point information of block data is referred to and, for example, it is confirmed that the content is the same as content supplied from another device [74]. The fact that the block data is data obtained by dividing the same content can be confirmed by referring to information inherent to content, for example, the date and time, ch (channel), broadcasting station (distribution company) name and the like provided (by the first content supply source, for example, broadcasting station or distribution company) for the respective content according to, for example, attribute data belonging to the respective content, the aforementioned EPG information, time information prepared as one of SI (Service Information) including EPG information and PMT (Program Map Table) of ES (Elementary Stream) contained in SI or playback time information contained in pack_header provided in a pack formed by connecting a preset number of PES packets each of which is obtained by forming ES in a packet form or the like.

When the same content is determined in the mutual block data items [74-YES], it is detected that no time deviation occurs in the mutual block data items [75].

If it is detected that no time deviation occurs in the mutual block data items [75-NO], data is received in parallel and stored in a previously provided buffer (copying is continuously performed) [78].

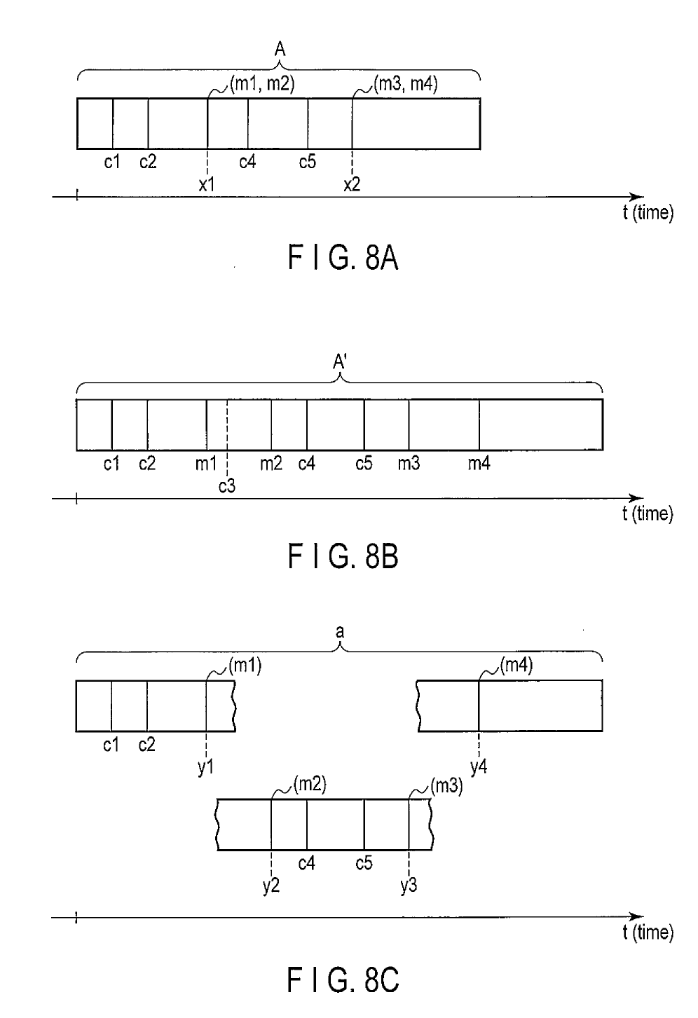

If a block in which time deviation occurs is present in the received block data [75-YES], it is detected that the time deviation can be adjusted according to the cause of the deviation [76-YES], the deviation is adjusted (compensated for) [77], and a block is reconstructed to set the time series with respect to other block data in a correct position [78]. The time deviation that can be adjusted will be explained with reference to FIG. 8 but, for example, there occurs a case where “CM (the presence or absence of commercial)” or the dividing point includes a common portion (including a portion in which data items are partially overlapped) before and after division is included.

When time deviation occurs in received block data [76-NO] and if it is difficult to adjust the deviation, for example, time information items do not coincide or the coincident ranges are greatly different or the like, it is preferable to interrupt reception and display (output display output) an alert (message) of, for example, ‘content of different block data items is included’.

FIGS. 8A, 8B and 8C each show an example in which coincidence is determined in a case where the total times (time lengths) do not coincide even though no time deviation occurs when received block data is reconstructed.

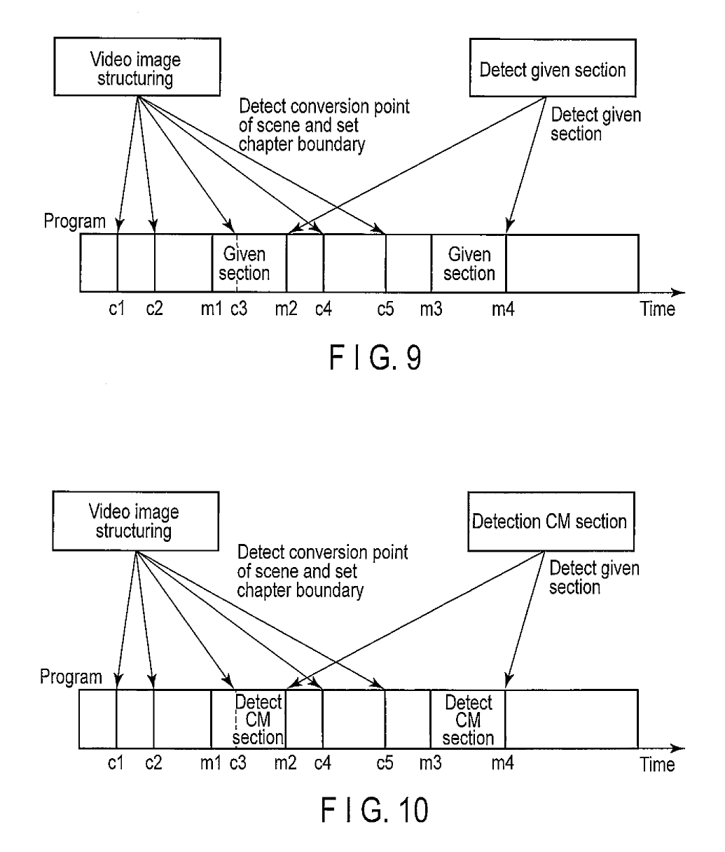

When received block data items are content item A (FIG. 8A) and content item A′ (FIG. 8B) whose total times are different although attribute data items belonging to respective block data items, EPG information items, SI including EPG information items are coincident and if it can be predicted that the non-coincident portion corresponds to a CM (commercial) portion, it can be considered that individual sections are set according to an already practiced “video image structuring” method (FIG. 9) and “given section detection” method (FIG. 10) for a “commercial” section included in the original version of the content (program).

For example, if chapter dividing points that can be expressed as c1, c2, . . . , c5 are detected according to a “video image structuring” processing part shown in FIG. 9, dividing information items m1, m2, m3, m4 (silent sections) in a time direction of the same program (content) are detected according to a “given section detection” processing part shown in FIG. 10 and, for example, sections between m1 and m2 and between m3 and m4 that are sections in which a sound mode is kept unchanged and continuous or a stereo mode is continuous are set as “given sections”, then specified given sections can be detected as CM sections.

Therefore, if editing position x1 contained in the block data shown in FIG. 8A is a continuing portion between m1 and m2 in content item A′ and editing position x2 is a continuing portion between m3 and m4 in content item A′, it can be determined that both are the same block data of continuous content.

Further, as shown in FIG. 8C, when content item A includes connecting portions y1, y2, y3, y4, it can be specified that intervals between y1 and y2 and between y3 and y4 are given overlapping sections (so-called “margin”) used by block data for edition of content based on time information, that is, m1 included in y1 and m2 included in y2 or m3 included in y3 and m4 included in y4.

Next, a copy control process for “content data (content item A)” in which block data divided and transmitted to the receiving device is reconstructed is explained.

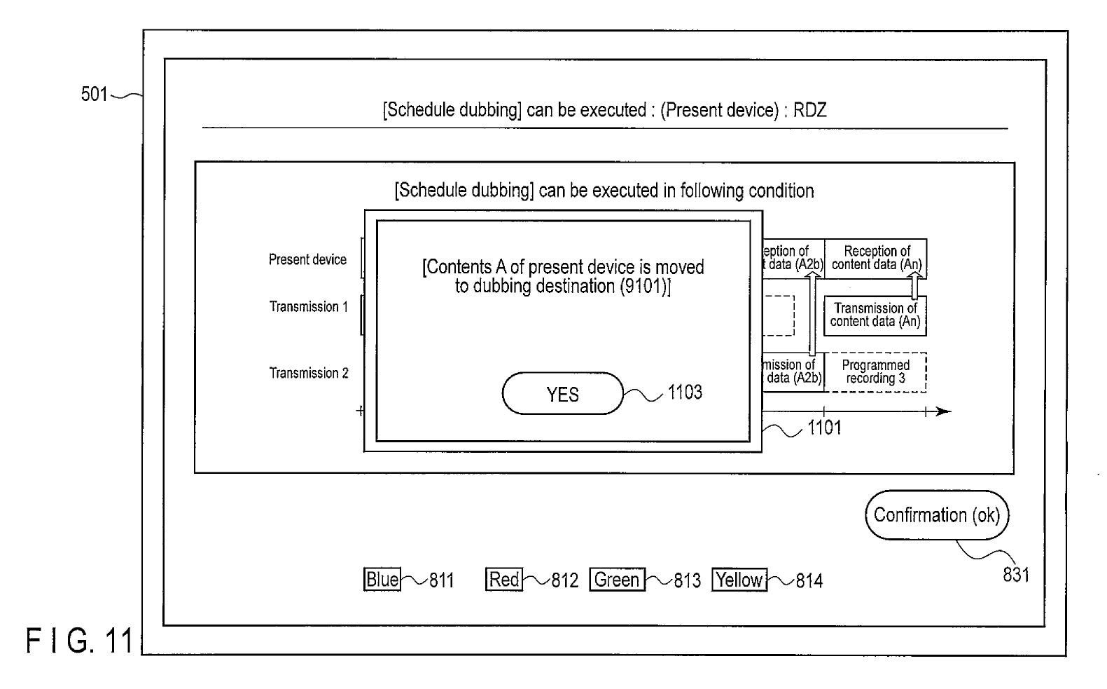

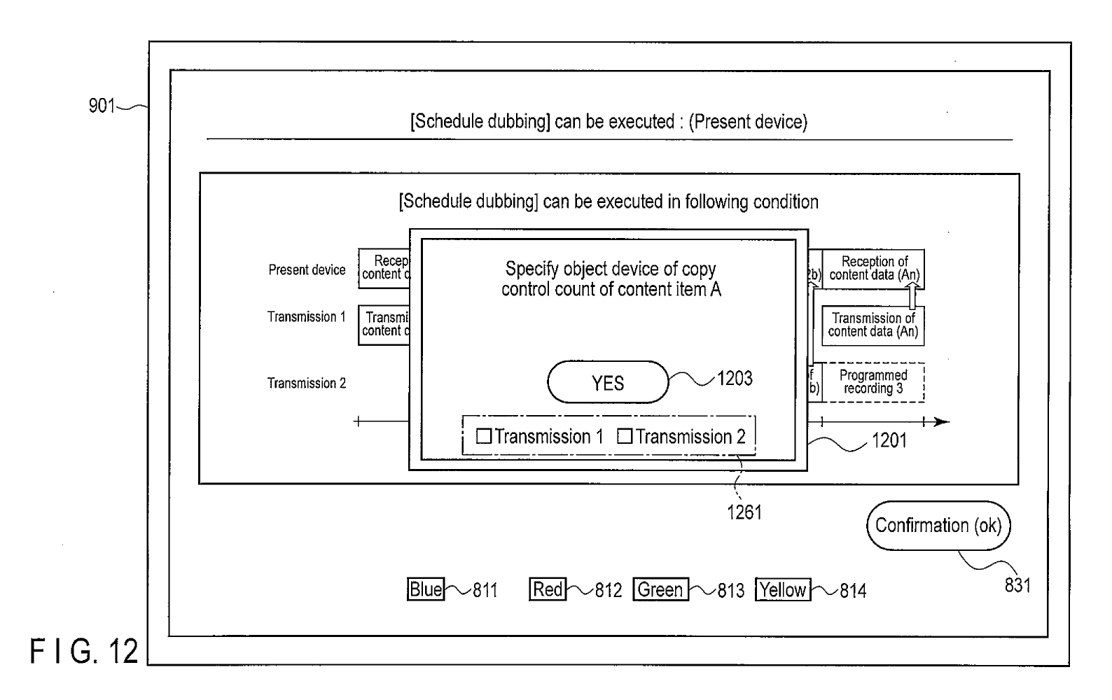

FIG. 11 and FIG. 12 each show an example of setting (confirmation) screen display of a “copy control process (copy control)”.

Since degradation in digital content (program/information/title) supplied from the broadcasting station (broadcasting company) or distribution company at the copying time is less, “Copy Once” in which copying is substantially inhibited (only a move (moving) is permitted) and (so-called) “Dubbing 10” in which the upper limit of the number of copies is provided, for example, copies of nine times are permitted and 10^{th} copying is performed as a move are performed. In the case of a BS system (broadcast provided by Broadcasting Satellite) of the terrestrial digital broadcasting and satellite broadcasting (the sampling frequency is less than 48 kHz), “Dubbing 10” is applied and in the case of a CS system (broadcast relayed via Communication Satellite) of the satellite broadcasting (the sampling frequency is 48 kHz), “Copy Once” is applied.

Therefore, in order to make valid content received by the receiving device according to the aforementioned dividing move, that is, parallel transmission (parallel reception), confirmation (approval) of the user with respect to content held on the transmitting device side for content (content item A obtained by reconstructing block data) recorded on the receiving device becomes necessary by applying the copy control process explained with reference to FIG. 6. For confirmation (approval) of the user, for example, an alert (message) 1101 of ‘content is moved to the recording device 101 because the content is subjected to “Copy Once” and a ‘confirmation’, ‘execution” or ‘YES’ display 1103 that urges the confirmation (approval) thereof as shown in an example in FIG. 11 for content to which “Copy Once” is applied is displayed by using a graphical user interface (GUI) or on-screen display (OSD). In practice, the alert (message) 1101, it is preferable to display a ‘type name’ acquired from a MAC address or a ‘connection name’ in the network/mutual recording system connected via HDMI or the like, is displayed in screen 901.

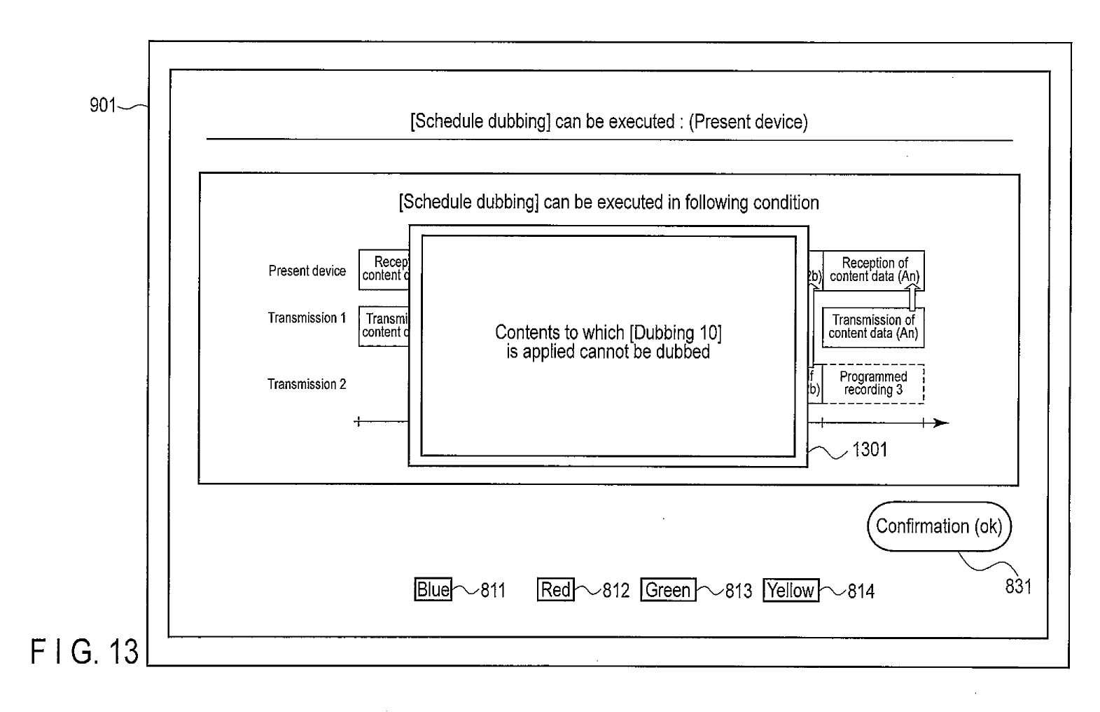

On the other hand, an alert (message) 1201 of ‘setting of copy limitation’ a ‘confirmation’, ‘execution” or ‘YES’ display 1203 that urges the confirmation (approval) thereof and an input request display of a setting unit 1261 of, for example, a “check box” type that can select or input a device that executes copy limitation and the like are displayed as shown in an example in FIG. 12 for content to which “Dubbing 10” is applied is displayed in screen 901 of the recording device 101. In practice, the alert (message) 1201 and/or the check box (the setting unit) 1261 and ‘confirmation’, ‘execution” or ‘YES’ display 1203, it is preferable to display a ‘type name’ acquired from a MAC address or a ‘connection name’ in the network/mutual recording system connected via HDMI or the like, is displayed in screen 901. In FIG. 12, if a device name that executes copy limitation is not input, it is preferable to display an alert (message) 1301 of ‘copying of content to which “Dubbing 10” is applied cannot be executed, for example, ““terminate” or make a setting (inputting) on a screen returned by use of a “return” button” as shown in an example in FIG. 13 after a preset time, for example, after an elapse time of 15 seconds and terminate the display after a preset time, for example, after an elapse time of 15 seconds.

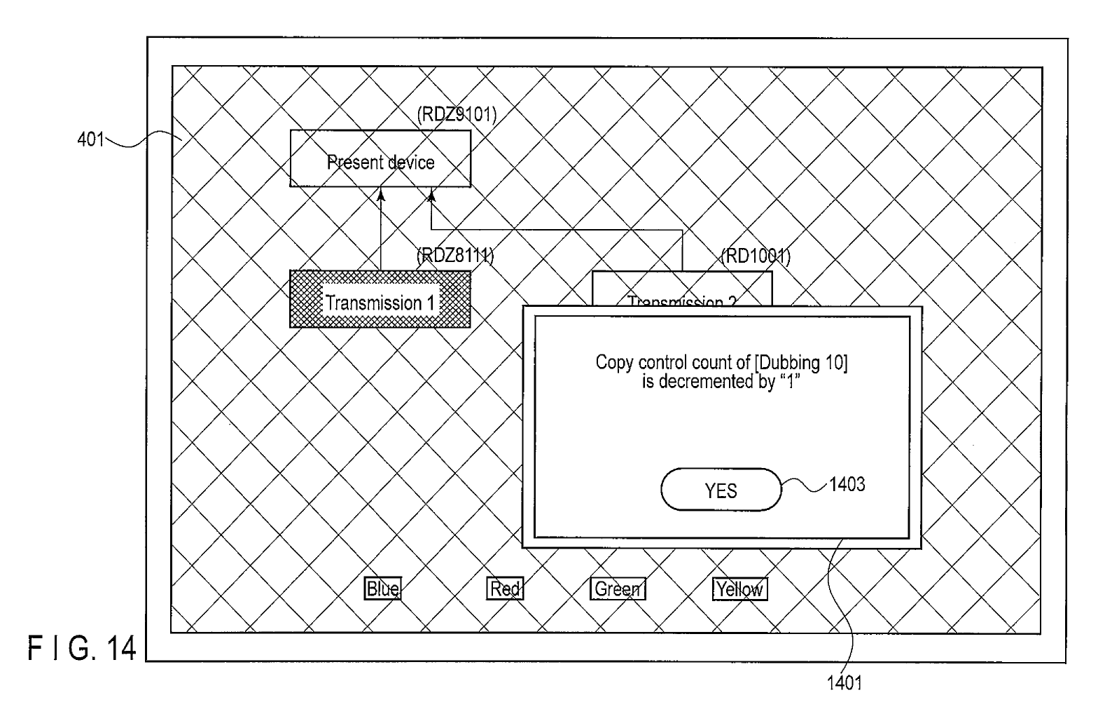

When the alerts (messages) shown in FIG. 11, FIG. 12 and FIG. 13 are displayed by use of On Screen Display (OSD), the whole portion of a guide screen that indicates a connection between the mutual recording devices is set in a “semitransparent” state by setting a parameter of α blending to a suitable value, for example, as shown in FIG. 14, a part of a normal video signal is made transmissible or a change in density is given thereto and displayed by gray-down display or the like and an alert (message) 1401 and an object recording device whose copy limitation count becomes “−1” by “Dubbing 10” can be emphasized and displayed. Further, a ‘confirmation’, ‘execution” or ‘YES’ display 1403 that urges the confirmation (approval) thereof is displayed.

On the alert (message) display shown in FIG. 13, for example, ‘a copy limitation count is decremented by “1” on the recording device 101 may be displayed and copying may be automatically started. In practice, the alert (message) 1301, it is preferable to display the ‘type name’ that can be acquired from a MAC address, ‘connection name’ in the network/mutual recording system connected via HDMI or the like, is displayed in screen 901.

In the “copy control process” explained in FIG. 13 and FIG. 14, a set screen is prepared and, for example, the user may be permitted to select ‘the copy limitation count of the recording device that has transmitted the final section of content is decremented by “1”’/‘the recording device that decrements the copy limitation count by “1” is set every time’ or the like.

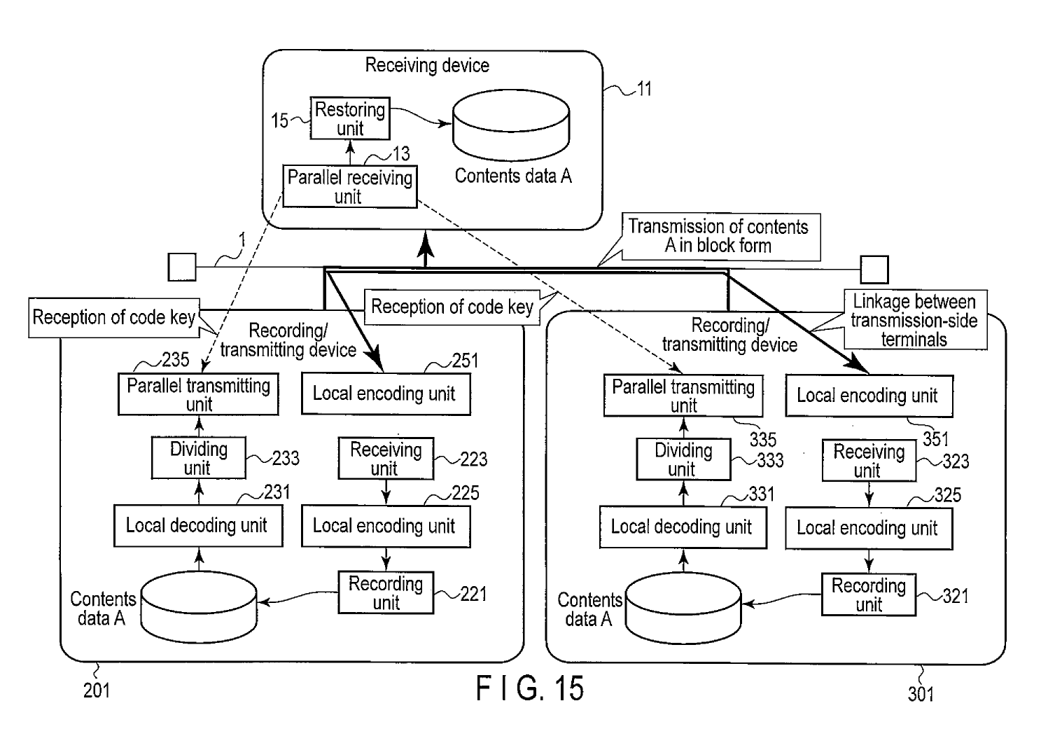

FIG. 15 shows an example in which block data is transmitted in parallel to a receiving device like the case of FIG. 1 when two transmitting devices that hold the same content item A (content data) are provided.

In FIG. 15, a first transmitting device 201 and second transmitting device 301 that can supply block data to a receiving device 11 provided on a network 1 respectively include terminal linkage units 251 and 351 that take partial charge of (are in charge of) a linkage process between the mutual transmitting devices.

The terminal linkage units 251 and 351 are effective when the encoding speed in the individual transmitting devices 201 and 301, the speed of the transmission process is lower than the reception speed of the receiving device 11 (the speed of the reception process) or the decoding speed or the communication speed of the network 1 is sufficiently higher than the transmission speed of the individual transmitting devices or the like. That is, the transmission speed of the transmitting device can be increased by permitting the individual transmitting devices 201 and 301 to take partial charge of transmission of block data of [A] to [C] and transmission of block data of [D] to [F] explained with reference to FIG. 2B. Further, when two or more transmitting devices are provided, for example, a check sum (CRC (Cyclic Redundancy Check)) can be used in addition to the aforementioned method (header/footer/index/resume point information, that is, meta information such as a reconstruction (restoration) code or EPG) explained in FIG. 7, FIG. 8A, FIG. 8B, FIG. 8C, FIG. 9 and FIG. 10 to determine identity of content data (block data).

An example in which a plurality of transmitting devices shown in FIG. 15 are provided is advantageous in a case where, for example, a plurality of external storages are present, the size of content to be moved is large and the content cannot be stored in one of the external storages. That is, content that cannot be stored in one external storage can be stored (can be received by the receiving device) by dividing the content into a given number of block data items and dispersedly moving the data items into a plurality of external storages.

Specifically, when divided block data items transmitted from a given number of transmitting devices are received and played back by a single receiving device, the divided block data items can be reconstructed as described above, and therefore, can be treated as one content item at the playback time. As a result, it becomes possible to seamlessly view (play back) the content divided into a given number of data items in a correct time series.

Next, an example in which the dividing process, that is, parallel transmission (and parallel reception) is applied to acquisition of available capacity of the storage is shown.

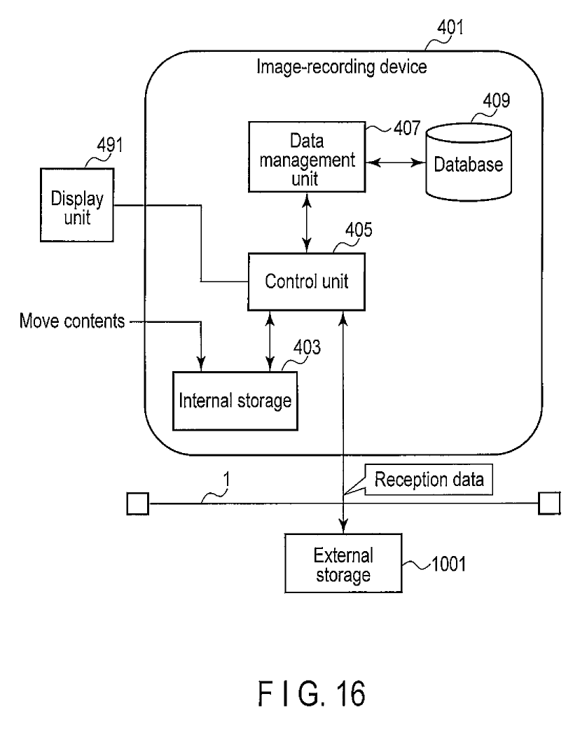

As shown in one example in FIG. 16, when a recording device (recording/playback device) positioned on the network and an external storage (storage device) are provided, the degree of convenience is enhanced in a case where the recording capacity of the recording/playback device is temporarily increased to record content that is inhibited from being returned again to the recording/playback device after a “move” to an extractable disk medium as in the case of, for example, “Copy Once” by applying the dividing process, that is, parallel transmission (and parallel reception) described above to a portion between the recording/playback device and the storage device.

For example, when content having a sampling frequency of 48 kHz and the high density of 1980×1080 ([1080p]) are recorded on the recording/playback device, a capacity of 12 G (giga) is required for content of approximately one hour. At this time, if the parallel transmission can be performed with the degree (m) of parallelization with m=3, a time (save time) required for acquiring the recording capacity corresponding to one hour in the recording/playback device becomes approximately 20 minutes. If, for example, two or more external storages are acquired, content of the large size can be divided and dispersedly saved (moved) to a given number of external storages.

That is, in a recording/playback device 401 shown in FIG. 16, content data received by the reception unit is held in an internal storage 403.

A control unit 405 confirms available capacity of the internal storage 403 and moves the content to an external storage 1001 if the capacity is less than a certain threshold value.

If the available capacity of the internal storage 403 is not less than a different threshold value, content that has been moved to the external storage can be restored in the internal storage 403 (returned to the original state).

A data management unit 407 updates data held in a database 409 for moved content information or discard the same.

When a display unit 491 is prepared, content information or data is acquired from the control unit 405 and data management unit 407 and content moved to the external storage 1001 is played back and can be displayed on the display unit 491.

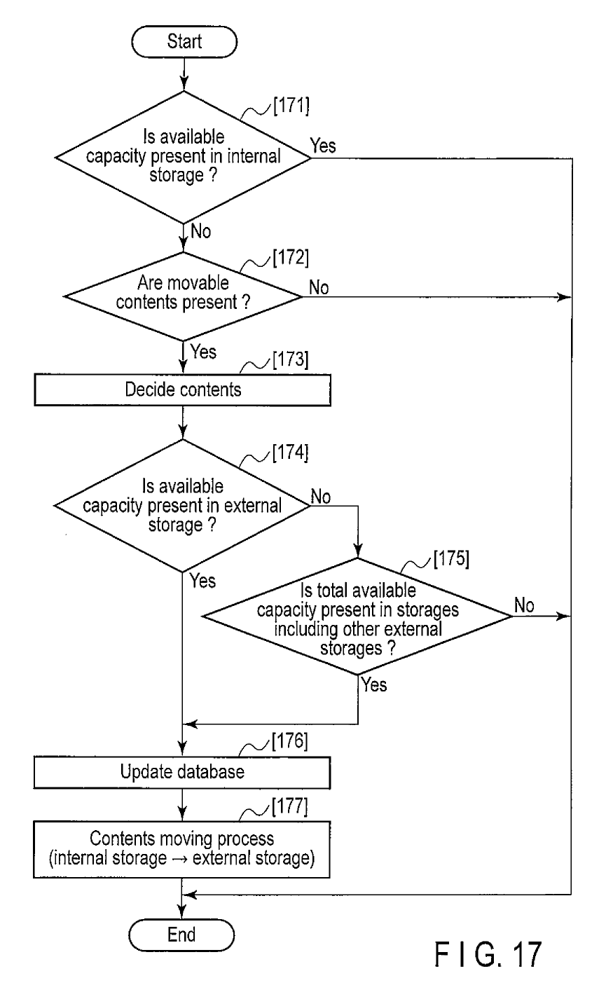

More specifically, as shown in FIG. 17, for example, the available capacity of the internal storage is confirmed approximately once for every 10 minutes [171].

When the available capacity of the internal storage becomes less than a certain threshold value, whether or not content that can be moved (to the external storage) are present is confirmed [172]. For example, it is supposed that

A) content data in which protection setting is not made by the user and

B) content data that is viewed or played back once or more are selected as to-be-moved content. If a plurality of content items that become candidates are present, content corresponding to a period that has elapsed long after the content are last viewed and played back are preferentially selected [172].

When (to-be-moved) content are determined [173], for example, whether available capacity is present in the external storage by using

a) a storage something that can be recognized from the recording/playback device (something authenticated as a valid moving destination),

b) a storage something whose available capacity is not less than a threshold value for the size of moved content and

c) a storage something whose available capacity is preferentially selected when a plurality of external storages are provided as a reference [174].

In the case of a single external storage, if available capacity that permits movable content to be saved (temporarily moved) is not present [174-NO], the total available capacity of a given number of external storages that can be recognized by the recording/playback device is calculated and whether or not it is larger than the size of moving content is determined [175].

If available capacity that permits movable content to be saved (temporarily moved) is acquired [174-YES]/[174-NO to 175-YES], the database is updated for identification of to-be-moved content [176] and object content are moved in an order of from an internal storage to an external storage [177].

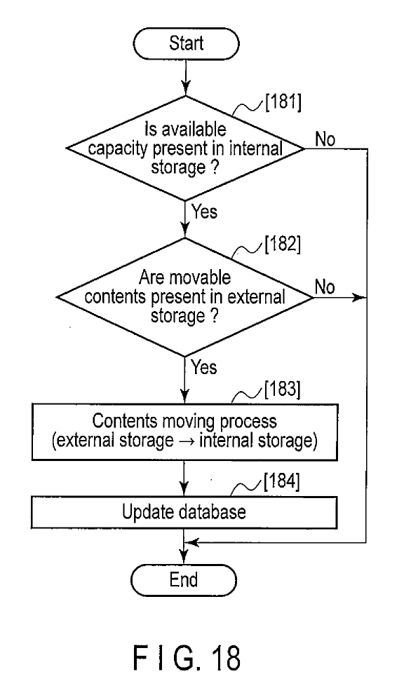

FIG. 18 shows an example of a process for returning content moved to the external storage as shown in FIG. 17 to the internal storage (refer to FIG. 16).

Initially, the available capacity of the external storage is confirmed [181]. If the available capacity is not less than a certain threshold value [181-YES], whether or not movable content are present in the external storage is confirmed. For example, movable content are specified according to the fact that

1) the content data are content moved from the internal storage in the past,

2) the protection setting is not made by the user for the content data,

3) the available capacity is less than a threshold value for the available capacity of the internal storage of the content data and

4) the period after content data are moved from the internal storage to the external storage is short [182].

Consequentially, content are present in the external storage is confirmed to-be-moved that are determined to be movable (can be returned to the internal storage) are moved from the external storage to the internal storage [183].

Then, the database for identification for the moved content is updated [184].

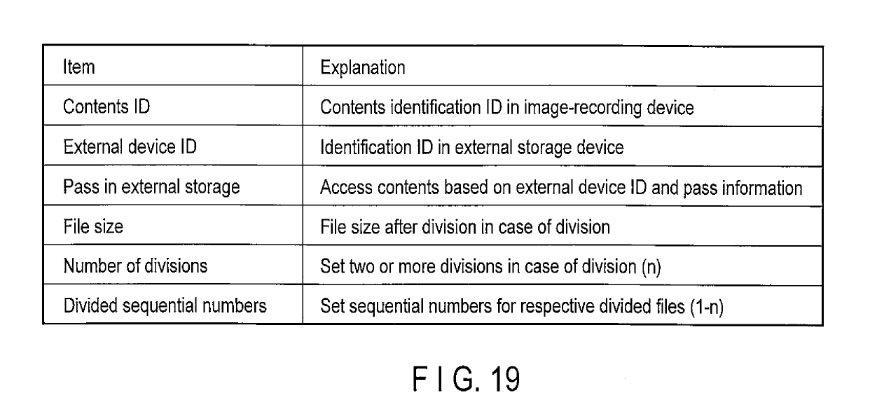

“Divided information” related to divided and moved content explained in FIG. 16, FIG. 17 and FIG. 18 can be displayed in a list form shown in FIG. 19.

In FIG. 19, accesses can be sequentially made to the divided files in an order of “external device ID”; “pass in external storage”; “number of divisions”; and “divided sequential numbers” described in the database.

Therefore, when divided block data items are sequentially played back (according to a time series),

a) accesses are made to the files in an order of “divided sequential numbers” of the database and data can be played back (viewed).

In this case,

b) a seamless playback process can be performed by comparing “file size” of the database with the data size actually played back, detecting a time immediately before the end of playback of a given one file and starting buffering of playback of a next file.

Since divided individual block data items are set in a locally encoded state before and after moving by means of n (n is a positive integral number) encoding units included in the parallel transmission unit of the transmitting device and N (N is a positive integral number) decoding units included in the parallel reception unit of the receiving device as described above with reference to FIG. 1, the individual block data items transmitted from the transmitting device can be securely transferred (moved) to the receiving device 11 and it is difficult to view data from another device. When the moving process from the external storage to the internal storage is performed, files (block data items) are moved to the internal storage in an order of “divided sequential numbers” of the database and combined/restored (reconstructed). In this case, all of the database information (created) for division is discarded.

Each of the recording devices (transmitting devices/receiving devices/recording/playback devices) at least includes an interface unit that transfers content (block data) with respect to another device via the network, a recording/playback processing unit that writes (records) content in the recording unit and reads (plays back) the content from the recording unit and a main control unit that controls writing of content to the recording/playback processing unit, playback of content from the recording/playback processing unit and each element/configuration. Further, each recording device at least includes an encoder for recording information, a decoder for playing back information and the like.

If each (given) recording device has a reception function of a television broadcast, a program (content/title/information) received by a receiver unit (not shown) and selected by a tuner unit (not shown) is encoded by the encoder and recorded to the recording unit via the recording/playback processing unit. Further, for example, this is also applied to analog information (content/program/title) input as external input.

On the other hand, when playback of information (content/program/title) is instructed, information read from the recording unit by means of the recording/playback processing unit is decoded by the decoder and output to an output unit (not shown) as Video output (or still image) and Audio output (speech/music). If a monitor device (display) and speaker are prepared, an output video image and speech (speech/music) are played back.

A display example can be acquired by freely combining display methods used for the display.

Thus, the efficiency of use of the network can be enhanced by performing divisional transmission (parallel transmission) and parallel reception of content by using the marginal region of the network.

Further, the user can reduce a time required for the copy process between the device and the degree of convenience at the terminal use time can be enhanced.

A plurality of terminals can commonly have the same content and the viewable environment of the user can be expanded.

Further, image recording (recording of content) can be executed while available capacity permitting content to be recorded is kept acquired without moving content that are difficult to be returned again to the recording/playback device to an extractable recording medium after removing or moving existing content.

Since an image-recording (recording) process and saving process can be performed in parallel, available capacity can be acquired even if the image-recording time is not securely set. Further, since the image-recording (recording) process and saving process can be performed in parallel, useless saving of content does not occur even if the recording process is interrupted on the way.

Since content can be recorded in the internal storage (by saving a part of the content in the external storage) even if available capacity becomes insufficient, a function that is difficult to be achieved in image-recording (recording) with respect to the external storage can be used.

Further, since content that are already viewed are temporarily saved to the external storage and new content are held in the internal storage, a function that is permitted only in the internal storage and is impossible in the external storage, for example, a chapter function or double-speed playback function becomes effective for new content that will be played back with a high possibility.

The moved content can be returned to the internal storage and available capacity of the external storage can be suppressed from being simply reduced. Further, a function that cannot be used in the external storage can be used by returning the moved content to the internal storage.

Content that cannot be moved as they are (the space that is large enough to independently store data in the external storage is not provided) because the size thereof is large can be dispersedly moved to a plurality of external storages and the degree of convenience can be greatly enhanced.

In the series of above explanations, the operation of two or more recording devices that hold to-be-copied content can be realized in various cases wherein, for example, a single content is separately recorded in two or more recording devices, content held in a given recording device are copied to another recording device in a copy controllable range and content are recorded twice or more when the content are supplied plural times by repetitive broadcasting (re-broadcasting) or the like.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A transmitting apparatus comprising:
a divider configured to divide recorded content into block data items;
one or more encoders configured to encode the block data items; and
a transmitter configured to transmit the encoded block data items and arrangement information indicative of a position of content before division with a degree M of parallelization of at least M=1.

2. The transmitting apparatus of claim 1, further comprising:
a receiver configured to receive individual block data items transmitted by the transmitting module with the degree M; and
a restorer configured to restore the individual block data items to content before division according to arrangement information.

3. The transmitting apparatus of claim 2, wherein the restorer is configured to restore content obtained by restoring the received block data to content before transmission.

4. The transmitting apparatus of claim 1, further comprising:
a data move controller configured to periodically confirm available capacity of an internal storage, move content formed in a block data form from the internal storage to an external storage, and move content formed in a block data form from the external storage to the internal storage.

5. The transmitting apparatus of claim 1, further comprising:
a data manager configured to create a database of content formed in a block data form divided by the divider, and update the database according to a result of reconstruction of content.

6. The transmitting apparatus of claim 1, further comprising:
a linkage processor configured to control transmission of block data formed in a block data form by another recording device that holds the same content and transmission of block data formed in a block data form by its own device for each block data.

7. The transmitting apparatus of claim 1, further comprising:
a receiver configured to receive content;
a local encoder configured to locally encode the received content;
a recorder configured to record the locally encoded content;
a local decoder configured to locally decode the locally encoded content; and
a storage module configured to hold move information of content.

8. A copying method comprising:
dividing content into a block data form;
adding management information for reconstruction to individual block data items formed in the block data form; and
encoding the individual block data items for the respective block data items to be reconstructed according to the management information and transmit the same with a degree M of parallelization of at least M=1.

9. A copying method comprising:
decoding individual block data items received with a degree of parallelization of at least 1 for each block data;
acquiring management information for reconstructing original content based on individual decoded block data items; and
reconstructing content from the individual received block data items based on the acquired management information.
